(19) United States
(12) Patent Application Publication
(10) Pub. No.: US 2024/0103265 A1
(43) Pub. Date: Mar. 28, 2024

(54) ROTATABLE POLYGON MIRROR, OPTICAL DEFLECTOR, OPTICAL SCANNING DEVICE AND IMAGE FORMING APPARATUS

(71) Applicant: CANON KABUSHIKI KAISHA, Tokyo (JP)

(72) Inventors: TAKATOSHI TANAKA, Shizuoka (JP); ATSUSHI TAKATA, Kanagawa (JP); YOSHIHIKO TANAKA, Shizuoka (JP); NAOKI MATSUSHITA, Shizuoka (JP)

(21) Appl. No.: 18/458,254

(22) Filed: Aug. 30, 2023

(30) Foreign Application Priority Data
Sep. 22, 2022 (JP) 2022-151928

(51) Int. Cl. G02B 26/12; G02B 5/09; G03G 15/043

(52) U.S. Cl. CPC G02B 26/121; G02B 5/09; G03G 15/0435

(57) ABSTRACT

A rotatable polygon mirror molded with a resin includes a plurality of reflecting surfaces provided in parallel to a rotational axis direction, a surface perpendicular to the rotational axis direction; a plurality of gate portions provided on the surface and a recess-projection on the surface. The recess-projection has at least one shape of a recess shape recessed in the rotational axis from the and a projection shape projected from the surface as viewed in a direction perpendicular to the rotational axis direction. The recess-projection is provided in a virtual straight line with equal distances from two of the adjacent gate portions with respect to a rotational direction of the rotatable polygon mirror and connecting a rotation center of the rotatable polygon mirror and a boundary of two of the adjacent reflecting surfaces with respect to the rotational direction.

### FIELD OF THE INVENTION AND RELATED ART

The present invention relates to a rotatable polygon mirror, an optical deflector, an optical scanning and an image forming apparatus. For example, it relates to an image forming apparatus such as a copier, a printer and a fax machine, and relates to a rotatable polygon mirror, an optical deflector and an optical scanning device which are used for the image forming apparatus such as the copier, the printer and the fax machine.

The optical deflector, on which the rotatable polygon mirror which is formed by cutting metallic material such as aluminum with high precision is mounted, is used in the optical scanning device. Part (a) of FIG. 10 is a schematic sectional view showing an internal configuration of a conventional optical deflector. In a conventional optical deflector, a rotatable polygon mirror 131 is supported by a flange portion 1341 which is a support member which is made of metallic material. A lot of machining man-hours are necessary to cut and finish the metal material such as aluminum, which is used as base material of the rotatable polygon mirror 131, with high precision. Furthermore, the conventional rotatable polygon mirror 131 is managed by printing manufacturing information with ink, etc., which leads to an increase in machining man-hours. On the other hand, in recent years, forming the rotatable polygon mirror by resin molding is being attempted. It is possible to significantly reduce the machining man-hours which are required to process the rotatable polygon mirror by resin molding. For example, Japanese Laid-Open Patent Application (JP-A) 2019-191333 discloses a polygon mirror (rotatable polygon mirror) which is shown in part (b) of FIG. 10. Gates are provided with a mold which forms a surface which is perpendicular to a rotational axis, the rotatable polygon mirror is molded by injecting resin, and gate marks are formed at gate portions 1313 in the rotatable polygon mirror after molding. As one of means of printing manufacturing information of the rotatable polygon mirror which is made of resin, a method which engraves molding information on a mold and forms it on the surface of the rotatable polygon mirror is considered. This method is effective in reducing man-hours because the molding information is engraved on the rotatable polygon mirror while the rotatable polygon mirror is molded.

However, when applying the method of engraving the molding information which is described above to the rotatable polygon mirror which is made of resin, there are issues as follows. The rotatable polygon mirror which is made of resin and is used for the image forming apparatus is required to be molded with high precision. As shown in part (c) of FIG. 10, when projected portions or recessed portions are provided on the mold which is used during molding to provide recessed portions or projected portions on the surface of the rotatable polygon mirror, uneven resin filling is occurred due to changes of resin flow during molding. As a result, surface accuracy of a reflecting surface 1311 and a supported portion 1314 which contacts the flange portion 1341 in part (a) of FIG. 10, which require high surface accuracy, may decrease.

In response to the above issue, it is an object of the present invention to provide a rotatable polygon mirror which is made of resin and is molded with high precision while it includes recess-projection shaped portions.

### SUMMARY OF THE INVENTION

According to an aspect of the present invention, there is provided a rotatable polygon mirror molded with a resin comprising: a plurality of reflecting surfaces provided in parallel to a rotational axis direction and configured to reflect a light, a first surface and a second surface perpendicular to the rotational axis direction, a plurality of gate portions provided on the first surface or the second surface and being marks through which the resin is injected during molding the rotatable polygon mirror, and a recess-projection shaped portion provided on the first surface or the second surface, and as viewed in a direction perpendicular to the rotational axis direction having at least one shape of a recess shape recessed in the rotational axis from the first surface or the second surface and a projection shape projected in the rotational axis direction from the first surface or the second surface, wherein the recess-projection shaped portion is provided in a virtual straight line with equal distances from two of the adjacent gate portions with respect to a rotational direction of the rotatable polygon mirror and connecting a rotation center of the rotatable polygon mirror and a boundary of two of the adjacent reflecting surfaces with respect to the rotational direction.

Further features of the present invention will become apparent from the following description of exemplary embodiments with reference to the attached drawings.

### BRIEF DESCRIPTION OF THE DRAWINGS

FIG. 1 is a sectional view showing an image forming apparatus according to a first embodiment and a second embodiment of the present invention.

FIG. 2 is a perspective view showing an optical scanning device according to the first embodiment and the second embodiment.

FIG. 3 is a schematic sectional view showing an internal configuration of an optical deflector according to the first embodiment and the second embodiment.

Part (A) of FIG. 4 is a front view and part (B) of FIG. 4 is a sectional view of a rotatable polygon mirror according to the first embodiment and the second embodiment.

FIG. 5 is a conceptual diagram showing resin flow during molding of the rotatable polygon mirror according to the first embodiment and the second embodiment.

FIG. 6 is a diagram showing a state when the rotatable polygon mirror according to the first embodiment and the second embodiment is assembled to the optical deflector.

Part (a), part (b), part (c) and part (d) of FIG. 7 are diagrams illustrating phases of the rotatable polygon mirror according to the second embodiment and a flange portion and recess-projection amount of the surface of the flange portion.

Part (a) and part (b) of FIG. 8 are diagrams showing a phase adjusting method of the optical deflector according to the second embodiment.

FIG. 9 is a graph showing a phase adjusting amount and a tilt (inclination) of a reflecting surface according to the second embodiment.

Part (a) of FIG. 10 is a schematic sectional view showing an internal configuration of a conventional optical deflector, part (b) of FIG. 10 is a schematic view showing a rotatable polygon mirror and part (c) of FIG. 10 is a conceptual view showing changes in resin flow.

Part (A) part (B), part (C) and part (D) of FIG. 11 are views showing examples of an identification portion which is a recess-projection shaped portion.

### DESCRIPTION OF THE EMBODIMENTS

In the following, embodiments of the present invention will be described exemplarily in detail. However, dimensions, materials, shapes and relative arrangements, etc. of component parts which are described in the embodiment should be changed accordingly depending on a configuration and various conditions of an apparatus to which the present invention is applied. That is, it is not intended to limit a scope of the present invention to following embodiments.

### First Embodiment

### [Image Forming Apparatus]

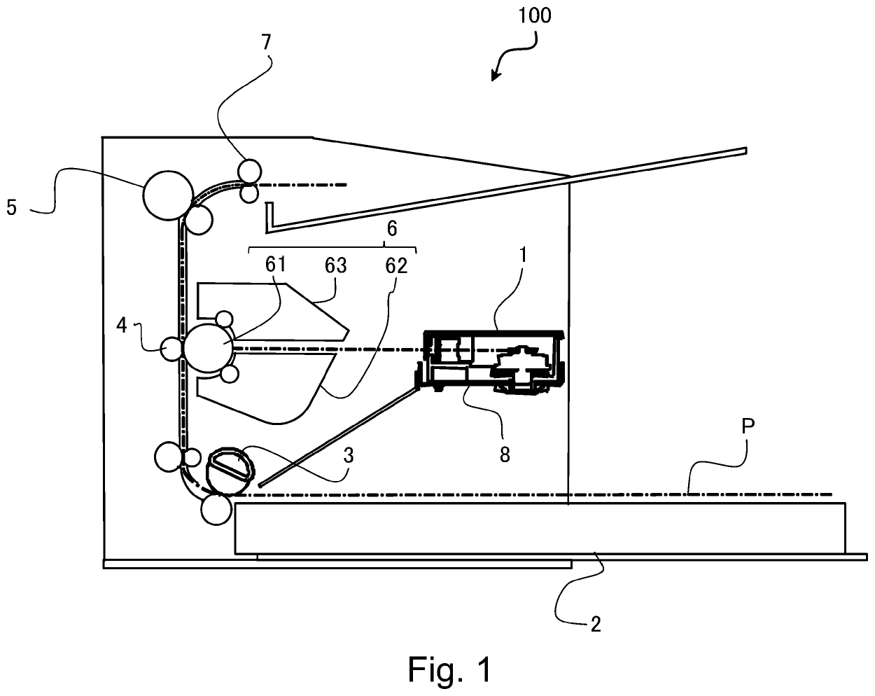

FIG. 1 is a view showing an image forming apparatus 100 which is a laser printer of electrophotographic type which applies the optical scanning device according to the first embodiment. An optical scanning device 1 is mounted on an optical table 8. The optical table 8 is a part of a casing of the image forming apparatus 100. In addition, the image forming apparatus 100 is provided with a sheet feeding portion 2 on which a transfer material P (recording material) such as paper is stacked, a sheet feeding roller 3, a transfer roller 4 as a transfer means and a fixing device 5 as a fixing means. Furthermore, in the image forming apparatus 100, a process cartridge 6, which is an image forming means, is arranged in a position which opposes the transfer roller 4 with respect to a conveying passage of the transfer material P. The process cartridge 6 includes a photosensitive drum 61 as an image bearing member and a developing device 62 which develops an electrostatic latent image which is formed on the photosensitive drum 61 to a toner image by toner. Furthermore, the process cartridge 6 includes a cleaning container 63 which collects toner which is remained on the photosensitive drum 61 (on the image bearing member) after the toner image is transferred onto the transfer material P. The transfer material P is fed from the sheet feeding portion 2 by the feeding roller 3, and the toner image which is formed on the photosensitive drum 61 is transferred by the transfer roller 4. After that, the unfixed toner image on the transfer material P is fixed to the transfer material P by heat and pressure in the fixing device 5. The transfer material P on which the toner is fixed is discharged to outside of the image forming apparatus 100 by a discharging roller 7.

### [Optical Scanning Device]

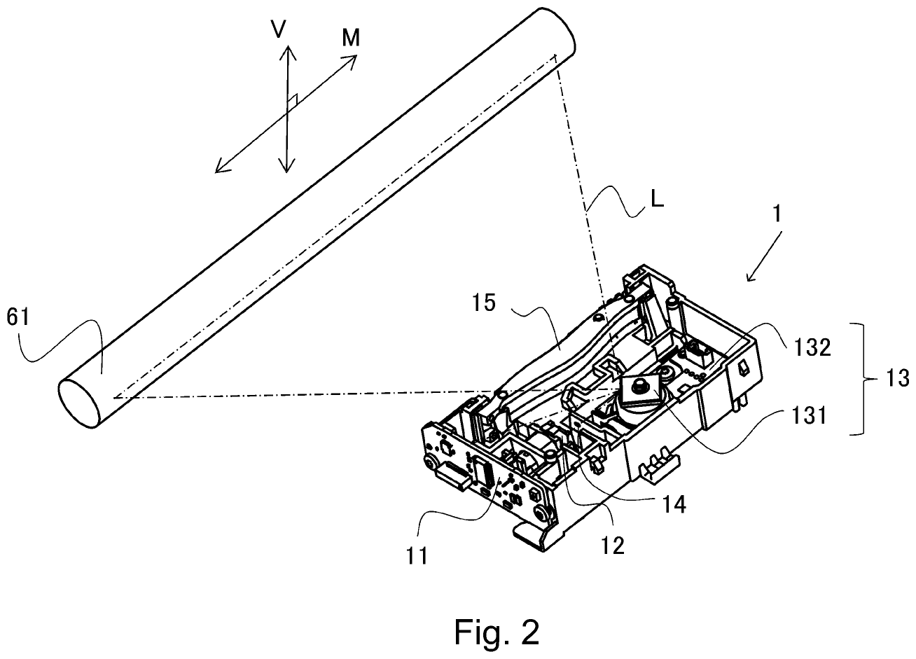

FIG. 2 is a perspective view showing a configuration of the optical scanning device 1 according to the first embodiment. Laser light L (single dotted line) which is emitted from a light source device 11 which includes a semiconductor laser, is condensed only in a sub scanning direction by a cylindrical lens 12. Here, a direction in which the laser light L is scanned is defined as a main scanning direction (arrow M in the figure), and a direction which is perpendicular to the main scanning direction, that is, a rotational direction of the photosensitive drum 61 is defined as the sub scanning direction (arrow V in the figure). Furthermore, the laser light L is limited to a predetermined beam diameter by an optical diaphragm 14 which is formed in an optical box which is molded of, for example, resin whose color is black (hereinafter referred as “black resin”). And the laser light L is condensed in a long line in the main scanning direction on a reflecting surface of the rotatable polygon mirror 131 which is part of an optical deflector 13. Incidentally, the reflecting surface which reflects the laser light L (light) is provided to be parallel to a direction of a rotational axis of the rotatable polygon mirror 131. The rotatable polygon mirror 131, which is part of the optical deflector 13, is rotationally driven by a driving motor 132 which is part of the optical deflector 13 and deflect and scan the laser light L incident on the reflecting surface of the rotatable polygon mirror 131. The laser light L which is deflected and scanned, after passing through an fθ lens 15, is condensed and scanned on the photosensitive drum 61 and forms an electrostatic image.

### [Optical Deflector]

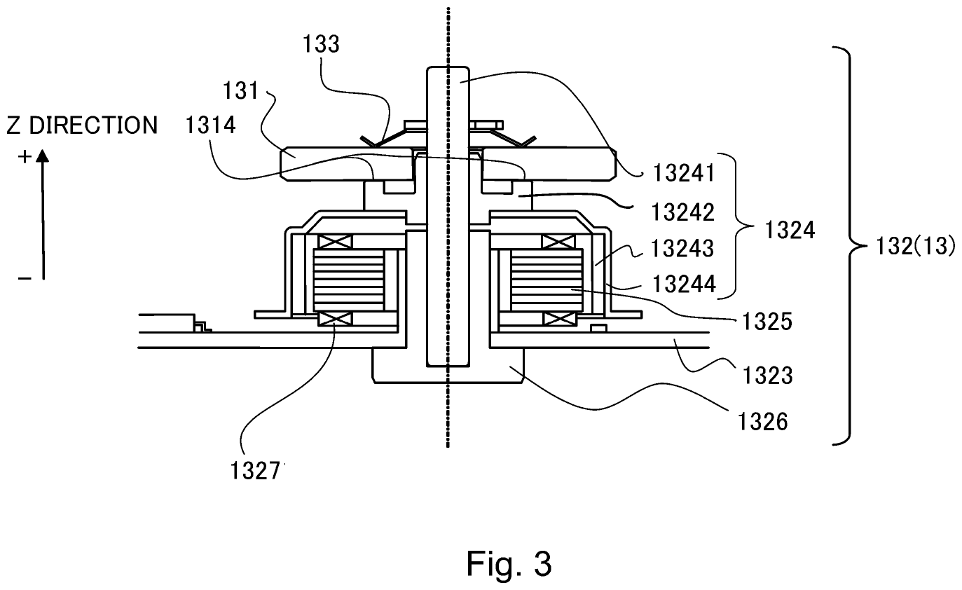

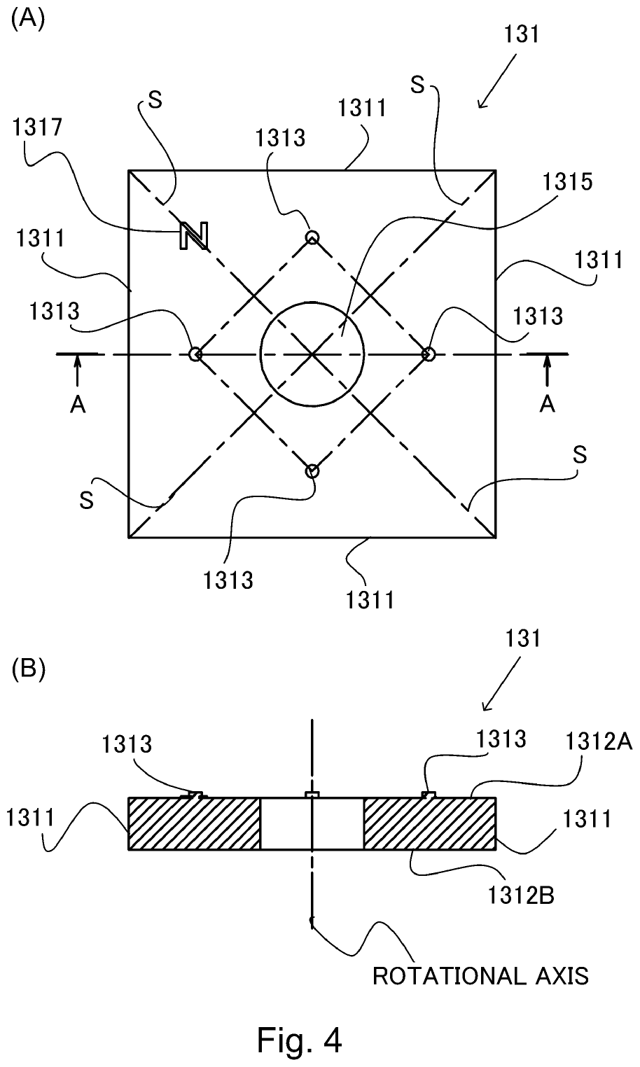

FIG. 3 is a schematic sectional view showing an example of an internal configuration of the optical deflector 13 in which the optical scanning device 1 according to the first embodiment includes. The driving motor 132 which rotates the rotatable polygon mirror 131 includes a rotor 1324, a stator core 1325 and a bearing 1326. The rotor 1324 includes a shaft 13241 which is supported by a bearing 1326, a flange portion 13242 as a supporting member, a rotor frame 13244 which is integrally connected to the flange portion 13242 by caulking, etc. and a rotor magnet 13243. The flange portion 13242 supports a surface 1312B, which will be described below, of the rotatable polygon mirror 131. The rotor frame 13244 (frame) accommodates the stator core 1325, a stator coil 1327 and the rotor magnet 13243. Incidentally, the stator core 1325, the stator coil 1327 and the rotor magnet 13243 are included in a driving means.

Further, by magnetic force in which the stator core 1325 and the stator coil 1327 which are fixed to a circuit board 1323 generate, the shaft 13241 rotates integrally with the rotor 1324, the rotatable polygon mirror 131, etc., while the shaft 13241 is engaged with the bearing 1326. Furthermore, the optical deflector 13 includes an elastic member 133 which generates force to press the rotatable polygon mirror 131 against the rotor 1324 in a direction of a rotational axis (Z direction in the figure) in order to rotate the rotor 1324 and the rotatable polygon mirror 131 integrally. The rotatable polygon mirror 131 contacts the flange portion 13242 at the supported portion 1314, and the elastic member 133 presses the rotatable polygon mirror 131 against the flange portion 13242 from a surface 1312A side (a first surface side) as will be described below.

### [Rotatable Polygon Mirror]

A shape of the rotatable polygon mirror 131 according to the first embodiment will be described below. Part (A) of FIG. 4 is a front view showing the shape of the rotatable polygon mirror 131 according to the first embodiment, and part (B) of FIG. 4 is a sectional view along line A-A in part (A) of FIG. 4. The rotatable polygon mirror 131 includes a hole 1315 which is formed of an inner surface surrounding the flange portion 13242 when the rotatable polygon mirror 131 is mounted on the flange portion 13242 of the driving motor 132 in FIG. 3. Further, the rotatable polygon mirror 131 includes the surface 1312A which is the first surface and the surface 1312B which is a second surface, which are perpendicular to the direction of the rotational axis. The rotatable polygon mirror 131 is contacted with and supported with the flange portion 13242 at the supported portion 1314. And the surface 1312A which is perpendicular to the rotational axis of the rotatable polygon mirror 131 is a surface on which the elastic member 133 presses the rotatable polygon mirror 131, and also includes the gate portions 1313.

The rotatable polygon mirror 131 includes the plurality of gate portions 1313, which is provided on the surface 1312A or the surface 1312B and includes marks in which resin was injected during molding. Incidentally, in the first embodiment, the plurality of gate portions 1313 are on the surface 1312A. At the gate portions 1313, marks, in which resin was injected during molding, remain. As shown in part (A) of FIG. 4 and part (B) of FIG. 4, the gate portions 1313 have cylindrical shape. The gate portions 1313 are provided near the reflecting surfaces 1311 of the rotatable polygon mirror 131 and are provided in the same number as the reflecting surfaces 1311. Incidentally, in the first embodiment, the rotatable polygon mirror 131 includes four reflecting surfaces, however, the number of the reflecting surfaces 1311 is not limited to four.

And the rotatable polygon mirror 131 includes an identification portion 1317, which is a recess-projection shaped portion which is molded on the surface 1312A or the surface 1312B. In the first embodiment, the identification portion 1317 is provided on the surface 1312A. More specifically, the rotatable polygon mirror 131 includes the identification portion 1317 which has at least one shape of a projection shape or a recess shape in order to identify information during molding of the rotatable polygon mirror 131 (hereinafter, referred to as molding information), at a position which intersects a virtual straight line with equal distances from two of the adjacent gate portions 1313 with respect to a peripheral direction of the rotational axis (rotational direction), and on a virtual straight line which connects a rotation center of the rotatable polygon mirror 131 and a boundary of two of the adjacent reflecting surfaces 1311 with respect to the rotational direction. Here, the virtual straight line with equal distances from two of the adjacent gate portions 1313 is defined as a virtual straight line S. In the first embodiment, the identification portion 1317 is provided on the surface 1312A in which the elastic member 133 which is shown in FIG. 3 presses the rotatable polygon mirror 131, however, it may be provided on the surface 1312B in which the rotatable polygon mirror 131 is supported from the flange portion 13242.

### [Molding Information]

The molding information according to the first embodiment will be described below. The rotatable polygon mirror 131 according to the first embodiment is molded by injection molding using the mold. On this occasion, in order to improve productivity, it is preferable to use the mold which is provided with a plurality of cavities and cores and to mold the plurality of rotatable polygon mirrors 131 at one time. In that case, it is necessary to determine which cavity and core the rotatable polygon mirror 131 was molded with, when it is found that it has such a problem that performance of the rotatable polygon mirror 131 does not meet specification. Therefore, information of the cavity and the core is engraved on the mold in advance, the rotatable polygon mirror 131 is molded, and recess-projection shape which is the information of the cavity and the core is provided on a surface of the rotatable polygon mirror 131. The identification portion 1317 according to the embodiment is projection shape. The information of the cavity and the core is included in the molding information. The molding information is not limited to the information of the cavity and the core, however, it may be other information such as date and location of molding. Further, the recess-projection shape of the identification portion 1317 may be only recess shape, only projection shape, or recess shape and projection shape. Furthermore, in part (A) of FIG. 4, the projection shape of the identification portion 1317 is represented as “N”, however, the projection shape may represent anything such as character, figure, symbol, one-dimensional or two-dimensional bar code. Further, in part (A) of FIG. 4, the identification portion 1317 is provided on one of the virtual lines S, however, it may be also provided on other virtual line S. Part (A), part (B), part (C) and part (D) of FIG. 11 are views showing examples of the recess-projection shape of the identification portion 1317. Part (A) of FIG. 11 is a view showing an example of an identification portion 1317SA which is projection shape which is same as in the first embodiment, and the identification portion is configured with projection shape in which the letter N is protruded from the surface 1312A. Part (B) of FIG. 11 is a view showing an example of an identification portion 1317SB which is recess shape, and the identification portion is configured with recess shape in which the letter N is recessed from the surface 1312A. Part (C) of FIG. 11 is a view showing an example of an identification portion 1317SC which is recess shape, and the identification portion is configured with recess shape in which a periphery of the letter N is recessed in a circle from the surface 1312A. In part (C) of FIG. 11, height of the letter N is the same height as the surface 1312A. Part (D) of FIG. 11 is a view showing an example of an identification portion 1317SD in which recess shape and projection shape are combined, and the identification portion is configured with recess-projection shape in which the letter N is protruded from the surface 1312A and the periphery of the letter N is recessed in the circle from the surface 1312A.

### [Resin Flow During Molding]

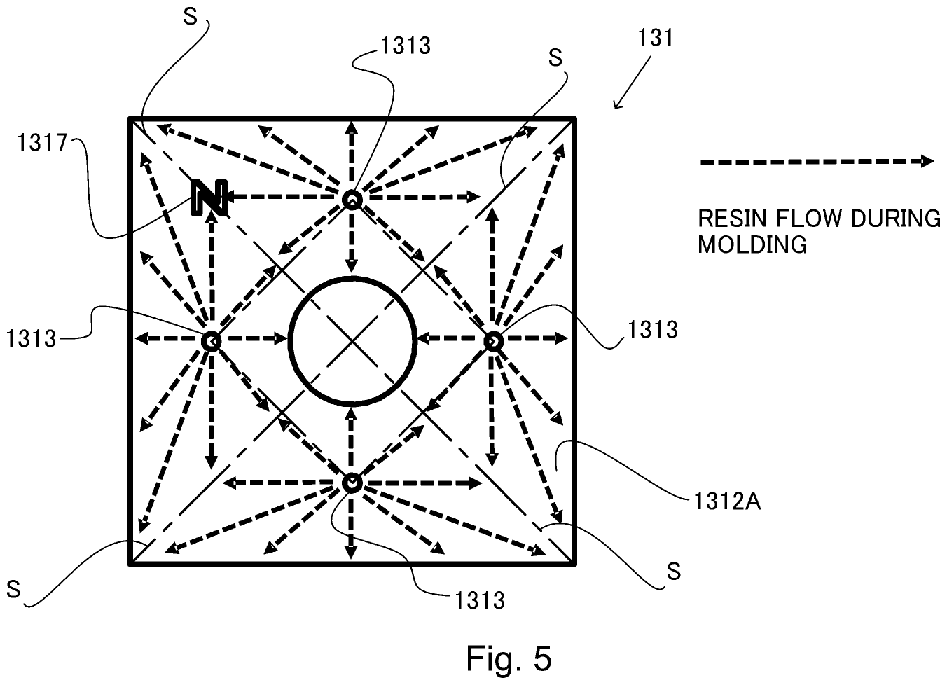

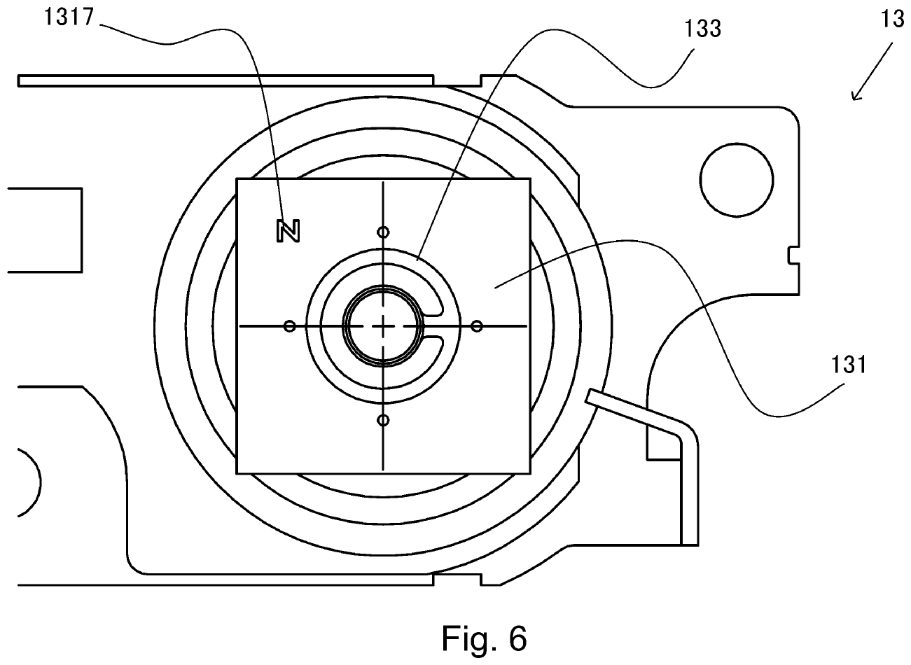

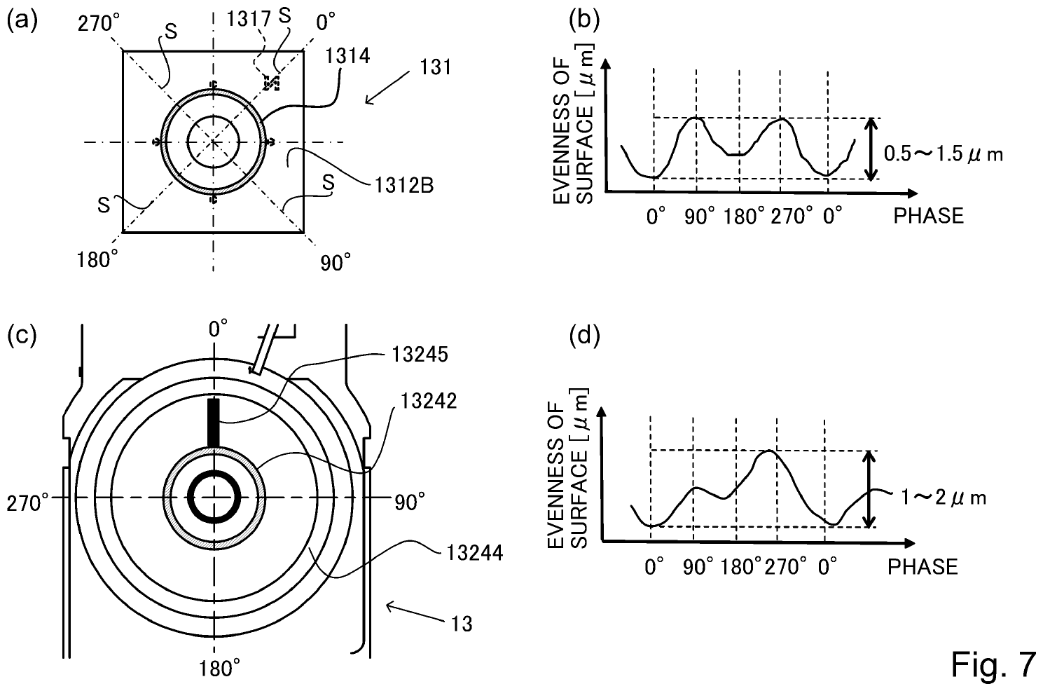

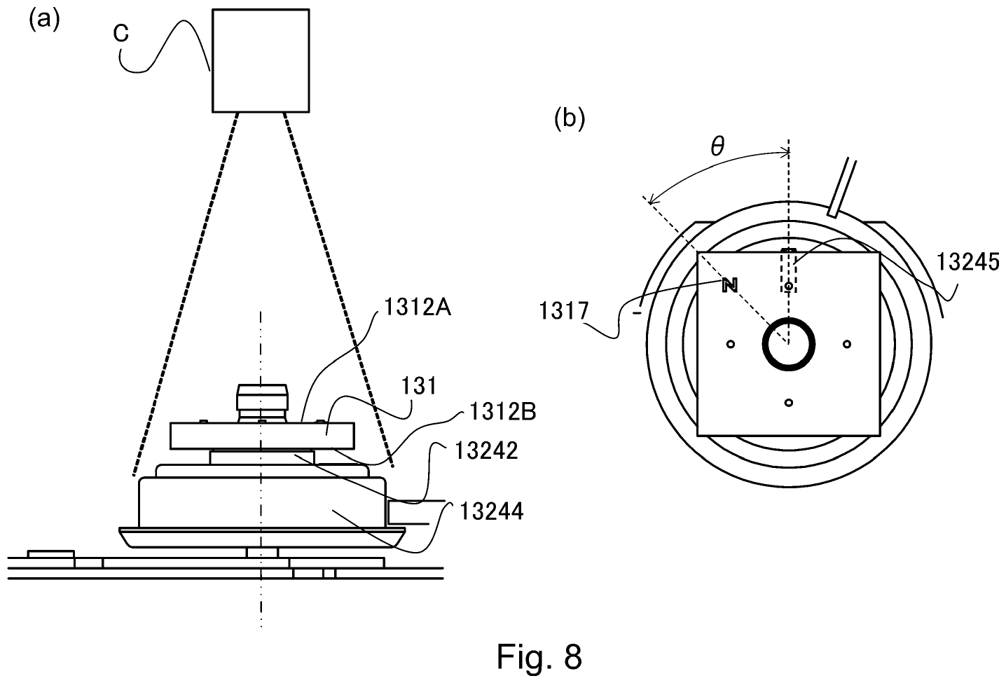

FIG. 5 is a view showing resin flows in the rotatable polygon mirror 131 during molding, which are indicated by dashed arrows. The resin spreads out concentrically from each of the gate portions 1313, and the virtual straight line S with equal distances from two of the adjacent gate portions 1313 is positioned at a downstream end of the resin flow. Incidentally, since four of the gate portions 1313 are provided, there are four of the virtual straight lines S. FIG. 5 is a view of the surface 1312A in the direction of the rotational axis of the rotatable polygon mirror 131, and the virtual straight lines S are represented by single dotted lines. The identification portion 1317 of the rotatable polygon mirror 131 is provided at a position on the virtual straight line S. That is, in the first embodiment, the identification portion 1317 is provided on the virtual straight line S which is positioned at the downstream end portion of the resin flow.

### (Position of the Identification Portion)

Part (c) of FIG. 10 is a diagram illustrating the mold and the resin flow when the rotatable polygon mirror which includes the identification portion is molded, and also shows the recessed portion of the mold which is the identification portion (the projected portion in a molded product). Part (c) of FIG. 10 shows a mold 1501 (upper mold) which includes a recessed portion 1502 to mold the identification portion which is projection shape, a mold 1503 (lower mold), and resin 1510. Three diagrams which are shown in part (c) of FIG. 10 indicate states when the resin 1510 is filling the cavity from left to right, and white arrows which are shown in the resin 150 indicate the resin flow.

As shown in part (c) of FIG. 10, when the recessed portion 1502 of the mold 1501 for molding the identification portion is provided in a middle of the flow of the resin 1510, unevenness of filling of the resin 1510 (uneven resin filling) may be caused by changing the flow of the resin 1510 and surface accuracy of the rotatable polygon mirror 131 may be reduced. Therefore, it is preferable that the recessed-projected portion which is provided on the surface of the rotatable polygon mirror 131 (that is the identification portion) is positioned as far downstream of the flow of the resin 1510 as possible. Thus, in the rotatable polygon mirror 131 according to the first embodiment, the identification portion 1317 which includes the molding information is provided in the virtual straight line S with equal distances from the adjacent gate portions 1313 with respect to the peripheral direction of the rotational direction.

### (Weld Line)

Weld lines which are generated during molding by resin may occur on the surface of the rotatable polygon mirror 131 which is in the virtual straight line S with equal distances from two of the adjacent gate portions 1313. The weld lines appear when a recessed portion, in which the surface of the rotatable polygon mirror 131 is not sufficiently filled with resin, is formed. When the weld lines are generated, mechanical strength of the rotatable polygon mirror 131 may be reduced. Therefore, in the first embodiment, the identification portion 1317 which is configured of the projected portion is provided in the virtual straight line S with equal distances from two of the adjacent gate portions 1313, in which the weld lines may be generated. In this way, it is possible to improve the mechanical strength of the rotatable polygon mirror 131.

It is preferable that the identification portion 1317 is provided outside of the rotatable polygon mirror 131 in a radial direction of the rotational axis with respect to a position in which the elastic member 133 presses the rotatable polygon mirror 131 in FIG. 3. That is, it is preferable that the identification portion 1317, which is a recess-projection shaped portion, is provided outside of an area in which the elastic member 133 presses the surface 1312A in the radial direction of the rotatable polygon mirror. FIG. 6 is a diagram when the optical deflector 13 according to the first embodiment is viewed in the direction of the axis of rotation. As shown in FIG. 6, the identification portion 1317 is provided outside of the elastic member 133 in the radial direction of the rotatable polygon mirror. By having such a configuration, it is possible to detect the identification portion 1317 while the optical deflector 13 is assembled and check the molding information of the rotatable polygon mirror 131.

In the first embodiment, the rotatable polygon mirror 131 which includes four of the gate portions 1313 on the rotatable polygon mirror which includes four of the reflecting surfaces 1311 is described, however, it is not limited to this. For example, it is possible to achieve similar effect even when the rotatable polygon mirror with more reflecting surfaces and more gate portions than this, the rotatable polygon mirror with fewer gate portions than the number of the reflecting surfaces, etc. are applied. It is possible to improve the accuracy of the reflecting surface of the rotatable polygon mirror which is made of resin by the configuration which is described above.

Thus, according to the first embodiment, it is possible to provide the rotatable polygon mirror which is made of resin while it includes the recess-projection shaped portion and is accurately molded.

### Second Embodiment

### [Surface Shape of the Rotatable Polygon Mirror and Surface Shape of the Flange Portion]

Part (a), part (b), part (c) and part (d) of FIG. 7 are schematic views showing recess-projection of the surface of the flange portion 13242 of the driving motor 132 and the surface accuracy of the surface of the supported portion 1314 of the rotatable polygon mirror 131, which are shown in FIG. 3. Part (a) of FIG. 7 is a diagram when the rotatable polygon mirror 131 is viewed in the direction of the rotational axis, more in detail, viewed from the surface 1312B side, and the supported portion 1314, which is supported by the flange portion 13242, is shown in hatching. Here, among four of the virtual straight lines S, the virtual straight line S which is provided with the identification portion 1317 is defined as phase 0°, a second virtual straight line S is defined as phase 90°, a third virtual straight line S is defined as phase 180°, and a fourth virtual straight line S is defined as phase 270°, with respect to clockwise toward the surface 1312B. Then, recess-projection (μm) which is a surface shape of the surface 1312B which is measured along the supported portion 1314 is shown in part (b) of FIG. 7. Part (b) of FIG. 7 is a graph showing the phase (°) on the horizontal axis and an amount of recess-projection of the surface 1312B (μm) on the vertical axis.

Part (c) of FIG. 7 is a diagram when the optical deflector 13 is viewed in the direction of the rotational axis, more in detail, viewed from the flange portion 13242 side, and an area, in which the flange portion 13242 abuts on the supported portion 1314, is shown in hatching. Here, a marker 13245 (marker portion) is defined as phase 0°, and each phase is defined as phase 90°, phase 180° and phase 270° with respect to clockwise in part (c) of FIG. 7. Then, recess-projection (μm) which is a surface shape of the flange portion 13242 which is measured along the area, in which the flange portion 13242 abuts on the supported portion 1314 is shown in part (d) of FIG. 7. Part (d) of FIG. 7 is a graph showing the phase (°) on the horizontal axis and an amount of recess-projection of the flange portion 13242 (μm) on the vertical axis.

Upon assembling the optical deflector 13 according to the second embodiment, a surface shape of the supported portion 1314 of the rotatable polygon mirror 131 (part (b) of FIG. 7) and a surface shape of the flange portion 13242 of the optical deflector 13 (part (d) of FIG. 7) are measured in advance. For example, the measurement result in part (b) of FIG. 7 shows that the supported portion 1314 of the rotatable polygon mirror 131 includes recess-projection shape ranging from 0.5 μm to 1.5 μm and it varies with phase, etc. Further, the measurement result in part (d) of FIG. 7 shows that the flange portion 13242 includes projection shape ranging from 1 μm to 2 μm and it varies with phase, etc.

For example, when the flange portion 13242 supports the supported portion 1314 of the rotatable polygon mirror 131 so that the phase 270° of the rotatable polygon mirror 131 and the phase 270° of the flange portion 13242 match, the projected surface of 1.5 μm overlaps the projected surface of 2 μm and an overall amount of projection is 3.5 μm. Then, at the phase 0° of the rotatable polygon mirror 131 and the phase 0° of the flange portion 13242, a surface in which recess-projection is approximately 0 μm overlaps a surface in which recess-projection is approximately 0 μm and an overall amount of recess-projection is approximately 0 μm. As a result, a difference of recess-projection between the phase 270° and the phase 0° becomes approximately 3.5 μm, and a tilt of the reflecting surface with respect to the rotational axis is different for each of the reflecting surfaces.

The rotatable polygon mirror 131 has a tendency of the surface shape of the supported portion 1314 for each cavity and core which are used during molding, and the surface shape is checked in advance by sample measurement as described above. On the other hand, the flange portion 13242 is precisely processed by a metal cutting machine, and a tendency of a surface shape during cutting is checked in advance by sample measurement. The surface shape of the rotatable polygon mirror 131 is measured with respect to a position of the identification portion 1317 (phase 0°) in the rotational direction as described above. On the other hand, the surface shape of the flange portion 13242 of the driving motor 132 is measured with respect to the marker 13245 which is provided on the rotor frame 13244. Here, the marker 13245 on the rotor 1324 is printed on the rotor 1324 with ink, etc. or provided with a geometric shape on the rotor frame 13244 itself.

And based on the measurement results in part (b) of FIG. 7 and part (d) of FIG. 7, the phase difference between the flange portion 13242 and the rotatable polygon mirror 131 is calculated such that the tilt of the rotatable polygon mirror 131 with respect to the shaft 13241 of the driving motor 132 when they are assembled is reduced.

### [Phase Adjustment Method]

Next, a phase adjustment method of the rotatable polygon mirror 131 and the driving motor 132 in the second embodiment will be described. Part (a) of FIG. 8 is a diagram showing how a phase relation between the rotatable polygon mirror 131 and the flange portion 13242 is detected by a phase detecting device C. Part (b) of FIG. 8 is a diagram showing an angle θ between the identification portion 1317 and the marker 13245 which is detected by the phase detecting device C.

As shown in FIG. 8, the rotatable polygon mirror 131 is loaded on the flange portion 13242. In this case, the phase relation between the identification portion 1317 which is provided on the rotatable polygon mirror 131 and the marker 13245 which is provided on the rotor frame 13244 is detected by the phase detecting device C which is a phase detecting means such as a camera from the direction of the rotational axis, and the angle θ is calculated. Here, the angle θ is an angle between the identification portion 1317 and the marker 13245.

The phase of the rotatable polygon mirror 131 and the phase of the flange section 13242 is adjusted so that the angle θ is the phase difference θ1, which is calculated in advance using the measurement results in part (b) of FIG. 7 and part (d) of FIG. 7, in which the tilt of the rotatable polygon mirror 131 is reduced. That is, the rotatable polygon mirror 131 is supported by the flange portion 13242, while the angle θ between the identification portion 1317 and the marker 13245 is adjusted so that difference among tilts of the plurality of reflecting surfaces 1311 with respect to the rotational axis is minimized. Incidentally, an amount of phase adjustment is defined as an amount of phase adjustment Δθ (=|θ1−θ|). And the rotatable polygon mirror 131 and the rotor 1324 are then fixed to rotate together by attaching the elastic member 133 shown in FIG. 3 and pressing the rotatable polygon mirror 131 against the flange 13242.

### (Amount of Phase Adjustment and Tilt of Reflecting Surface)

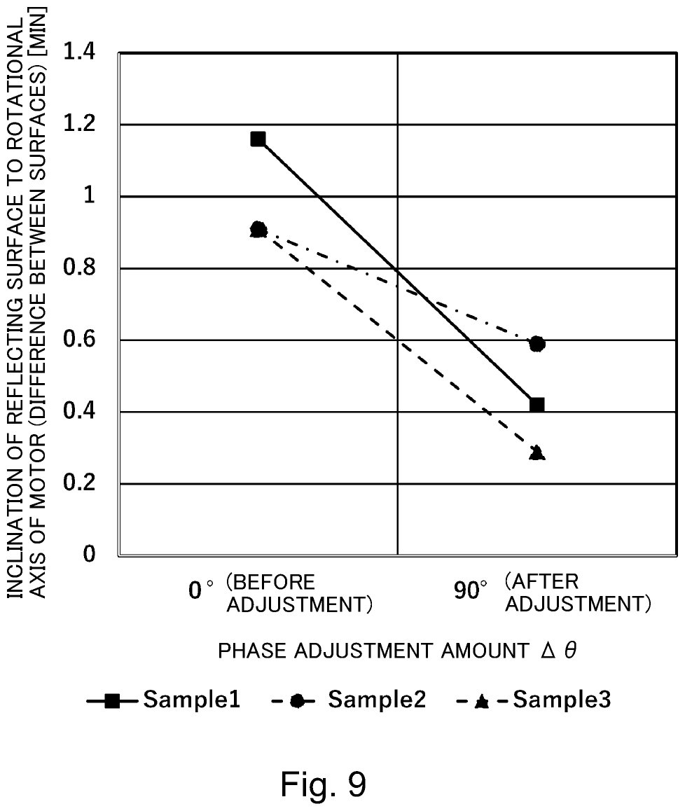

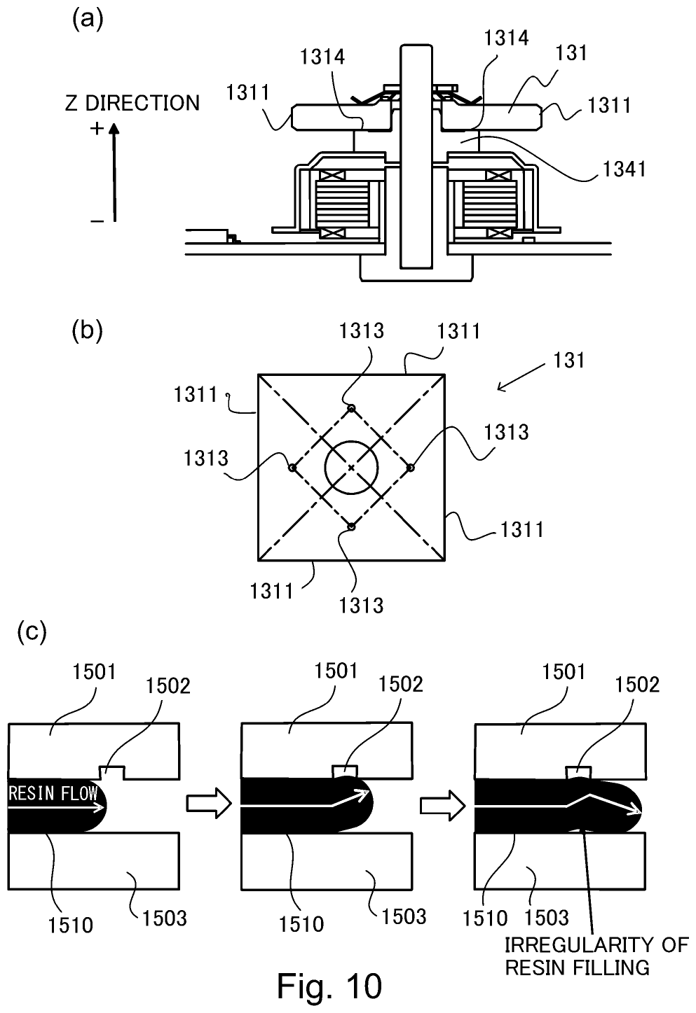

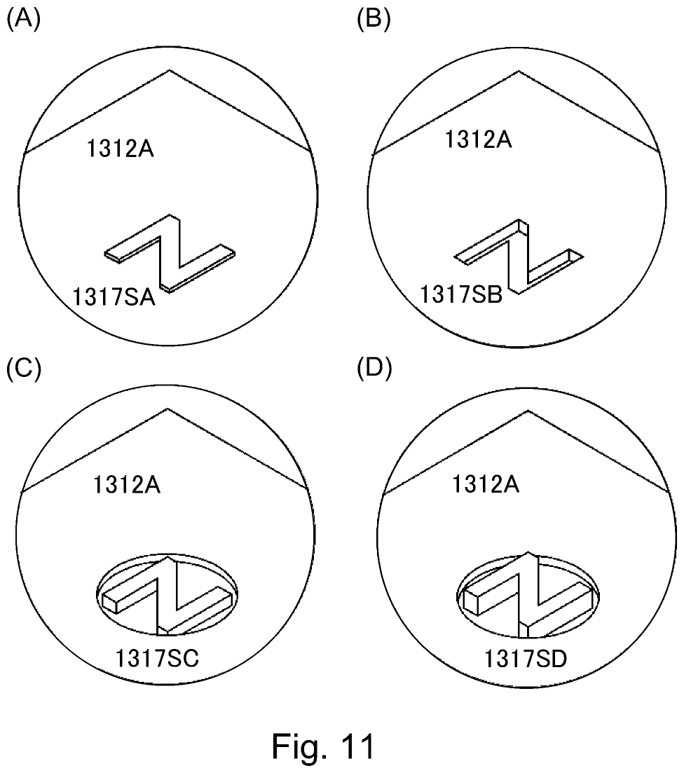

FIG. 9 is a graph showing the amount of the phase adjustment Δθ (°) before and after the phase adjustment and an amount (minute) of the tilt of the reflecting surface 1311 with respect to the rotational axis (the rotational axis of the motor). The amount of the phase adjustment Δθ is 0° before adjustment and 90° after adjustment. Here, the tilt of the reflecting surface indicates a relative difference for each reflecting surface (difference among surfaces). “Black square” indicates Sample 1, “black circle” indicates Sample 2 and “black triangle” indicates Sample 3. All three samples show that the tilt of the reflecting surface is significantly changed before and after the adjustment and that the tilt of the reflecting surface is improved after the adjustment. Incidentally, in FIG. 9, the amount of the phase adjustment Δθ is set as 90°, however, it is not limited to this.

Here, it is preferable that at least part of the surface 1312A and the surface 1312B which are perpendicular to the reflecting surface 1311 of the rotatable polygon mirror 131 in FIG. 8 is transparent. In recent years, the optical deflector 13 is becoming increasingly miniaturized, and the rotor 1324 is becoming smaller in diameter. When the phase detecting device C is mounted in the direction of the rotational axis of the optical deflector 13 to check the marker 13245, it may be difficult to detect the phase because the marker 13245 is hidden by the rotatable polygon mirror 131. Therefore, it is preferable that the rotatable polygon mirror 131 according to the second embodiment is configured of transparent resin material, and a part of the surface 1312A and the surface 1312B is transparent and it is configured so that it is possible to detect the marker 13245 through the rotatable polygon mirror 131.

Next, a shape of the identification portion 1317 which is provided on the rotatable polygon mirror 131 according to the second embodiment will be described. In a case that the rotatable polygon mirror 131 is molded from transparent material, it is difficult to determine upside or downside of the rotatable polygon mirror 131 by the phase detecting device C. Therefore, the rotatable polygon mirror 131 according to the second embodiment is possible to determine upside or downside of the rotatable polygon mirror 131 by making the identification portion 1317 a mirror surface asymmetric shape (different shape when viewed from the upside and viewed from the downside). It is possible to reduce the tilt of the reflecting surface of the optical deflector on which the rotatable polygon mirror which is made of resin is mounted by the configuration which is described above.

Thus, according to the second embodiment, it is possible to provide the rotatable polygon mirror which is made of resin while it includes the recess shaped portion and is accurately molded.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-151928 filed on Sep. 22, 2022, which is hereby incorporated by reference herein in its entirety.

What is claimed is:

1. A rotatable polygon mirror molded with a resin comprising:
a plurality of reflecting surfaces provided in parallel to a rotational axis direction and configured to reflect a light;
a first surface and a second surface perpendicular to the rotational axis direction;
a plurality of gate portions provided on the first surface or the second surface and being marks through which the resin is injected during molding the rotatable polygon mirror; and
a recess-projection shaped portion provided on the first surface or the second surface, and as viewed in a direction perpendicular to the rotational axis direction having at least one shape of a recess shape recessed in the rotational axis direction from the first surface or the second surface and a projection shape projected in the rotational axis direction from the first surface or the second surface,
wherein the recess-projection shaped portion is provided in a virtual straight line with equal distances from two of the adjacent gate portions with respect to a rotational direction of the rotatable polygon mirror and connecting a rotation center of the rotatable polygon mirror and a boundary of two of the adjacent reflecting surfaces with respect to the rotational direction.

2. A rotatable polygon mirror according to claim 1, wherein the recess-projection shaped portion is at least one of a character, a graphic, a symbol, a one-dimensional bar code and a two-dimensional bar code.

3. An optical deflector deflecting a laser light comprising:
a rotatable polygon mirror molded with a resin; and
a motor configured to support the rotatable polygon mirror and drive the rotatable polygon mirror,
wherein the rotatable polygon mirror includes:
a plurality of reflecting surfaces provided in parallel to a rotational axis direction and configured to reflect a light;
a first surface and a second surface perpendicular to the rotational axis direction;
a plurality of gate portions provided on the first surface or the second surface and being marks through which the resin is injected during molding the rotatable polygon mirror; and
a recess-projection shaped portion provided on the first surface or the second surface, and as viewed in a direction perpendicular to the rotational axis direction having at least one shape of a recess shape recessed in the rotational axis direction from the first surface or the second surface and a projection shape projected in the rotational axis direction from the first surface or the second surface,
wherein the recess-projection shaped portion is provided in a virtual straight line with equal distances from two of the adjacent gate portions with respect to a rotational direction of the rotatable polygon mirror and connecting a rotation center of the rotatable polygon mirror and a boundary of two of the adjacent reflecting surfaces with respect to the rotational direction.

4. An optical deflector according to claim 3, wherein the recess-projection shaped portion is at least one of a character, a graphic, a symbol, a one-dimensional bar code and a two-dimensional bar code.

5. An optical deflector according to claim 3, further comprising an elastic member configured to press the rotatable polygon mirror from a side of the first surface toward the motor,
wherein the recess-projection shaped portion is provided outside a portion where the elastic member presses the first surface with respect to a radial direction of the rotatable polygon mirror.

6. An optical deflector according to claim 5, wherein a rotor of the motor includes a rotor frame, and
wherein the rotor frame includes a marker portion to adjust a phase between the rotatable polygon mirror and the rotor with the recess-projection shaped portion.

7. An optical deflector according to claim 6, wherein at least a part of the first surface and the second surface is transparent.

8. An optical scanning device comprising:
a light source configured to emit a laser light; and
an optical deflector according to claim 3, the optical deflector being configured to deflect and scan the laser light emitted from the light source.

9. An image forming apparatus for forming a toner image on a recording material, the image forming apparatus comprising:
a photosensitive member; and
an optical scanning device according to claim 8, the optical scanning device being configured to scan the photosensitive member with a laser light and form an electrostatic latent image on the photosensitive member.

10. A rotatable polygon mirror molded with a resin comprising:
a plurality of reflecting surfaces provided in parallel to a rotational axis direction and configured to reflect a light;
a first surface and a second surface perpendicular to the rotational axis direction;
a plurality of cylindrical shape portions provided on the first surface or the second surface; and
a recess-projection shaped portion provided on the first surface or the second surface, and as viewed in a direction perpendicular to the rotational axis direction having at least one shape of a recess shape recessed in the rotational axis direction from the first surface or the second surface and a projection shape projected in the rotational axis direction from the first surface or the second surface,
wherein the recess-projection shaped portion is provided in a virtual straight line with equal distances from two of the adjacent cylindrical shape portions with respect to a rotational direction of the rotatable polygon mirror and connecting a rotation center of the rotatable polygon mirror and a boundary of two of the adjacent reflecting surfaces with respect to the rotational direction.

11. A rotatable polygon mirror according to claim 10, wherein the recess-projection shaped portion is at least one of a character, a graphic, a symbol, a one-dimensional bar code and a two-dimensional bar code.

12. An optical deflector deflecting a laser light comprising:
a rotatable polygon mirror molded with a resin; and
a motor configured to support the rotatable polygon mirror and drive the rotatable polygon mirror,
wherein the rotatable polygon mirror includes:
a plurality of reflecting surfaces provided in parallel to a rotational axis direction and configured to reflect a light;
a first surface and a second surface perpendicular to the rotational axis direction;
a plurality of cylindrical shape portions provided on the first surface or the second surface; and
a recess-projection shaped portion provided on the first surface or the second surface, and as viewed in a direction perpendicular to the rotational axis direction having at least one shape of a recess shape recessed in the rotational axis direction from the first surface or the second surface and a projection shape projected in the rotational axis direction from the first surface or the second surface,
wherein the recess-projection shaped portion is provided in a virtual straight line with equal distances from two of the adjacent cylindrical shape portions with respect to a rotational direction of the rotatable polygon mirror and connecting a rotation center of the rotatable polygon mirror and a boundary of two of the adjacent reflecting surfaces with respect to the rotational direction.

13. An optical deflector according to claim 12, wherein the recess-projection shaped portion is at least one of a character, a graphic, a symbol, a one-dimensional bar code and a two-dimensional bar code.

14. An optical deflector according to claim 12, further comprising an elastic member configured to press the rotatable polygon mirror from a side of the first surface toward the motor,
wherein the recess-projection shaped portion is provided outside a portion where the elastic member presses the first surface with respect to a radial direction of the rotatable polygon mirror.

15. An optical deflector according to claim 14, wherein a rotor of the motor includes a rotor frame, and
wherein the rotor frame includes a marker portion to adjust a phase between the rotatable polygon mirror and the rotor with the recess-projection shaped portion.

16. An optical deflector according to claim 15, wherein at least a part of the first surface and the second surface is transparent.

17. An optical scanning device comprising:
a light source configured to emit a laser light; and
an optical deflector according to claim 12, the optical deflector being configured to deflect and scan the laser light emitted from the light source.

18. An image forming apparatus for forming a toner image on a recording material, the image forming apparatus comprising:
a photosensitive member; and
an optical scanning device according to claim 17, the optical scanning device being configured to scan the photosensitive member with a laser light and form an electrostatic latent image on the photosensitive member.
